(19) United States
(12) Patent Application Publication
(10) Pub. No.: US 2018/0240060 A1
(43) Pub. Date: Aug. 23, 2018

(54) SYSTEMS AND METHODS FOR INTEGRATING ORDERED SERVICES

(71) Applicant: Wal-Mart Stores, Inc., Bentonville, AR (US)

(72) Inventors: Kyle Franklin Graham, Rogers, AR (US); Leslie Shawn Irvin, Gravette, AR (US); Tina Marie Kurtz, Rogers, AR (US)

(21) Appl. No.: 15/882,675

(22) Filed: Jan. 29, 2018

Related U.S. Application Data
(60) Provisional application No. 62/462,060, filed on Feb. 22, 2017.

(51) Int. Cl. G06Q 10/06

(52) U.S. Cl. CPC G06Q 10/06316; H04W 4/021; G06Q 10/06314

(57) ABSTRACT

Methods and systems for prioritizing and integrating ordered services are discussed. The system may include at least two display devices configured to display queues of services, a data storage device, and a server. The server may be configured to execute a prioritization module to receive a notification that a customer has checked in at a facility. The prioritization module may receive information associated with the customer that includes two or more services of different types ordered by the customer. The prioritization module may also determine an estimated duration of each ordered service of the two or more ordered services and determine a start time for performing each ordered service. The prioritization module may further add each ordered service to a queue and transmit an alert to the display devices indicating start times for beginning each ordered service.

### CROSS-REFERENCE TO RELATED PATENT APPLICATIONS

This application claims priority to U.S. Provisional Application No. 62/462,060 filed on Feb. 22, 2017, the content of which is hereby incorporated by reference in its entirety.

### BACKGROUND

Many facilities offer multiple types of services to their customers. The different types of services take differing amounts of time before they are completed. Frequently the services may be in physically separate parts of the facility.

### BRIEF DESCRIPTION OF DRAWINGS

To assist those of skill in the art in making and using a location-based identification system and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIG. 1 illustrates an exemplary network environment suitable for a system for prioritizing and integrating ordered services, in accordance with an exemplary embodiment;

FIG. 2 illustrates an exemplary method for integrating ordered services, in accordance with an exemplary embodiment; and

FIG. 3 is a block diagram of an exemplary computing device suitable for use in an exemplary embodiment.

### DETAILED DESCRIPTION

Described in detail herein are methods and systems for prioritizing and integrating ordered services. In an exemplary embodiment, the system is employed in a physical facility such as a retail store or business. The system includes a server communicatively coupled to a data storage device, at least two display devices each configured to display a queue of ordered services, and a user device, such as a smartphone or kiosk. The data storage device stores customer information and estimated durations of different types of services. The customer information includes two or more services ordered by a customer (hereafter referred to as “ordered services”) available to be performed at the facility. Ordered services are services that the customer would like performed in connection with a visit of the customer to the facility. Each ordered service is associated with a service type. For example, service types may include, but are not limited to, automotive repairs, food preparations, shopping, pharmacy orders, and money transfers. Each service type is associated with an estimated duration of time needed to complete the service.

The server may be configured to execute a prioritization module to receive a notification that the customer has checked in at the facility via a user device. In one embodiment, the notification includes customer credentials to retrieve customer information associated with the customer from the data storage device. The prioritization module may receive customer information associated with the customer from at least one of the data storage device or the user device. The customer information includes two or more services of different types ordered by the customer and available to be performed at the facility. The prioritization module may determine an estimated duration of each ordered service of the two or more ordered services. For example, the prioritization module may determine that a car repair service takes approximately 45 minutes to complete while a food preparation service takes approximately 15 minutes to complete. The prioritization module determines a start time for performing each ordered service of the two or more ordered services based on the expected duration of each type of ordered service such that the ordered services are scheduled to be completed at approximately a same time. For example, the prioritization module may assign the car repair service a start time of 1:00 p.m. and the food preparation service a start time of 1:30 p.m. such that both services are completed at approximately 1:45 p.m. The customer may then retrieve the repaired car and the prepared food at approximately the same time.

The prioritization module may also add the customer to a separate queue for each ordered service of the two or more ordered services based at least in part on the estimated duration for performing the service. Each queue may be associated with a predefined service type (e.g., automotive, money transfer, pharmacy, etc.). Each ordered service of the two or more ordered services may be added to a queue that shares a same service type. For example, the car repair service is added to a queue associated with car repairs.

In one embodiment, each display device of the at least two display devices may be configured to display a queue of services ordered by customers. Each queue includes services of a same service type and is viewable by one or more facility employees and/or the customer. In an exemplary embodiment, each display device is displayed in an area associated with the service. For example, a queue associated with car repairs may be displayed on a display device located in an automotive department.

The queue placement for an ordered service may be determined based at least in part on the estimated duration of the type of ordered service, the start time of the ordered service, and/or a number of customers in the queue. For example, the prioritization module may determine that by placing the customer as third in a queue, the customer will become first in the queue at approximately 1:00 p.m. when the car repair service will begin. It should be appreciated that the duration of the other services in the queue are also taken into account by the prioritization module when placing an ordered service in the queue.

In the exemplary embodiment, the prioritization module transmits an alert to each display device of the at least two display devices indicating the start time for beginning an ordered service. In the example above, an alert may be transmitted at 1:00 p.m. to a first display device located in the automotive department alerting the employees that the car repair service should begin. The prioritization module may further receive a notification from an employee that an ordered service of the two or more ordered services has been completed. The prioritization module may display the notification on the display device associated with the completed ordered service, thereby alerting employees and/or the customer that the ordered service is completed.

In one embodiment, the position of the services within the queue may be recalculated by the prioritization module after the ordered service is placed into the queue based on delays and other unanticipated situations.

The system may improve customer service by minimizing an individual's wait time to receive services, while also improving the ease and accuracy of performing multiple services. The system also enables employees to prioritize services since, instead of simply being based on time of arrival where all services begin at the same time and may end at different times, the prioritization module calculates when services should begin so that the services are completed at a same time. Therefore, a service associated with other services with a shorter time until all services are completed for a customer will be placed near a front of the queue by the prioritization module, and a service associated with other services that will take a longer time until all services are completed for a customer will be placed in the back of the queue. In one embodiment, customers that are members of a loyalty program or in a favored class may be assigned a higher priority and assigned favorable queue positions regardless of the regular service duration estimations and calculations. The system may further improve the efficiency of the computing environment by reducing network traffic by automating the authentication and prioritization of services at a location.

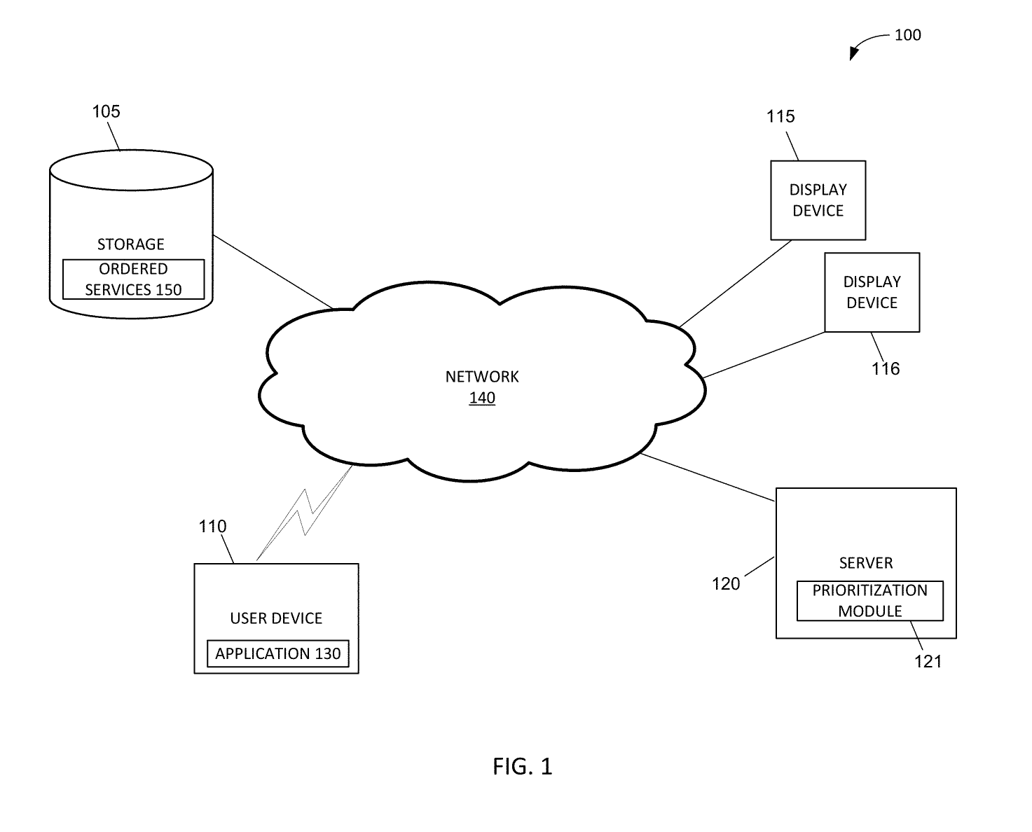

FIG. 1 illustrates an exemplary network environment suitable for a system 100 for prioritizing and integrating ordered services, in accordance with an exemplary embodiment. System 100 includes at least one data storage device 105 (one shown in FIG. 1), at least one user device 110 (one shown in FIG. 1), at least two display devices 115, 116 (two shown in FIG. 1), and at least one server 120 (one shown in FIG. 1) configured to execute a prioritization module 121. In an exemplary embodiment, user device 110 is a mobile computing device or a kiosk used by a customer. In an exemplary embodiment, user device 110 includes an application 130 configured to communicate with server 120 and prioritization module 121 via a communications network 140. Application 130 is configured to check into a facility, and/or provide user credentials and/or ordered services to server 120 and prioritization module 121. In some embodiments, user device 110 is a smartphone configured to use location-based wireless communication to check in to the facility, and application 130 is a mobile application installed on user device 110. In one example, Bluetooth® communication between a user's smartphone and a Bluetooth®-equipped device may be used to check in. One or more portions of communications network 140 is an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

As a non-limiting example, system 100 is associated with a physical facility such as a business or retail store. In the exemplary embodiment, user device 110 and display devices 115, 116 are located within the physical facility. Server 120 uses communications network 140 to communicate with user device 110 and display devices 115, 116.

In the exemplary embodiment, server 120 is further in communication with storage device 105 via communications network 140. Storage device 105 is connected to communications network 140 via a wired or wireless connection. Storage device 105 includes records of ordered services 150 for customers. Each ordered service is previously created by or for the customer using a computing device (for example, user device 110) and is associated with the customer. In some embodiments, the customer creates the two or more ordered services using application 130. Storage device 105 can be located at one or more geographically distributed locations from other storage devices 105 or from server 120. Alternatively, storage device 105 can be included with server 120.

The customer uses user device 110 to initiate performance of the two or more ordered services upon checking into the facility. In one embodiment, application 130 transmits a request for completion of the two or more ordered services to prioritization module 121. In another embodiment, application 130 is configured to transmit customer credentials (e.g., a customer name and a password) to prioritization module 121. Prioritization module 121 then retrieves from storage device 105 the information associated with the two or more ordered services for the customer using the customer credentials. In some embodiments, application 130 displays a list of the two or more ordered services to the customer. In further embodiments, the customer selects from a listing of application 130 services the two or more ordered services that the customer wants performed.

Upon receiving the request for the two or more ordered services from storage device 105 or user device 110, prioritization module 121 initiates performance of the two or more ordered services. Non-limiting examples of types of services include purchasing goods and services, preparing food, car cleaning and/or car repairs, processing a pharmacy order, financial services such as transferring or receiving money to/from a third party, receiving an electronic receipt (e.g., an e-receipt) from a purchase, and returning an item from the e-receipt.

Prioritization module 121 determines an estimated duration of each ordered service of the two or more ordered services by retrieving from data storage device 105 a stored estimated duration of each type of ordered service. Prioritization module 121 then determines a start time for performing each ordered service of the two or more ordered services based on the estimated duration of each type of ordered service, such that the two or more ordered services are scheduled to be completed at approximately a same time. Prioritization module 121 adds the customer to a separate queue for each ordered service of the two or more ordered services adjusting as necessary for services already in the queue. Each ordered service is added to a queue that shares a same service type.

A placement in the queue for an ordered service is determined based on the estimated duration of the type of ordered service, the start time of the ordered service, and how many services are currently in the queue. For example, a car repair service may take approximately 45 minutes to complete, with all ordered services being completed by approximately 1:00 p.m. If, for example, there are five cars waiting for service in a car repair queue (i.e., cars 1, 2, 3, 4, and 5) with the first two cars (i.e., cars 1 and 2) estimated to be completed by 12:15 p.m., the prioritization module 121 may place the ordered service in a third position in the queue (i.e., car 3 in cars 1, 2, 3, 4, 5, and 6) such that the ordered service is completed at approximately 1:00 p.m.

In one embodiment, the server's prioritization module may continually monitor the performance of all the tasks in the queue and recalculate queue order based on dynamic changes. For example, if a car repair being performed in the queue ends up taking longer than estimated, the remaining car services in the queue may have their position recalculated and may be re-slotted in the queue based on the change and their associated services (i.e. the other services for that user) so as to keep as many services as possible synchronized throughout the system. Alternatively, prioritized users may first be given higher positions in the queue following the change caused by service performance or other delays instead of solely attempting to keep as many service completion times synchronized. Alerts and notifications may be sent to user device 110, display device 115 and/or display device 116 following the recalculation.

The queue for each ordered service is displayed on user device 110, display device 115, and/or display device 116 and is viewable by at least by one or more facility employees or the customer. Prioritization module 121 may transmit alerts to display device 115, 116. Each alert is associated with an ordered service of the two or more ordered services and indicates a start time for employees to begin the ordered service. In an exemplary embodiment, the alert is transmitted when the ordered service becomes first in the queue. In alternative embodiments, the alert is transmitted when performance of the ordered service should begin so that the two or more ordered services are completed at approximately a same time, regardless of where the ordered service is located in the queue. In additional embodiments, prioritization module 121 further determines an estimated completion time of the two or more ordered services, and transmits the estimated completion time to user device 110, display device 115, and/or display device 116.

Prioritization module 121 may receive a notification that an ordered service of the two or more ordered services has been completed. Prioritization module 121 transmits the notification to the display device (e.g., display device 115 or display device 116) displaying the ordered service in the queue. After a predefined amount of time, prioritization module 121 then removes the completed ordered service from the queue. In some embodiments, prioritization module 121 transmits a notification to user device 110 that the two or more ordered services have been completed.

A non-limiting example of the system includes a customer at a physical facility such as a retail store using a specialized mobile application on a mobile computing device. The customer previously has ordered services whether through the mobile application or online that are not complete as they require some customer interaction with the facility (e.g. picking up purchases, money, returning an item, providing a car to be worked on, etc.). Exemplary services include without limitation purchases of goods, pharmacy orders, transferring or receiving money to/from a third party, auto services, and the return of items referenced by electronic receipts. Records of these ordered services are saved in a storage device and associated with the customer. At the facility, the customer may, using the mobile application and a location-based wireless communication capability, transmit the customer's identity and/or the ordered services to a server. As part of the ordered services being processed, the mobile application may transmit authentication data identifying the customer and location information to the prioritization module. The prioritization module determines a duration, a start time, and a queue placement for each ordered service. The queue associated with each ordered service is shown on a separate display device positioned, for example, in areas accessible by the customer and/or employees. Additional display devices may be located in other preferable locations in the store. The prioritization module transmits alerts to the display device that notify employees when to begin each ordered service, with the aim of scheduling ordered services to be completed at approximately a same time. For example, if the customer ordered pharmacy services, a pharmacy employee may be alerted to begin filling a prescription for the customer. If the customer also ordered car repair services, an automotive employee may be alerted to begin the car repair. Once the pharmacy employee and the automotive employee have completed the services, each employee notifies the prioritization module (for example, using a computing device in communication with the server) that the ordered service is complete. The prioritization module displays on each display device that the ordered service is complete and ready for the customer. A notification that the second of the services has been completed may be sent to the customer by the prioritization module.

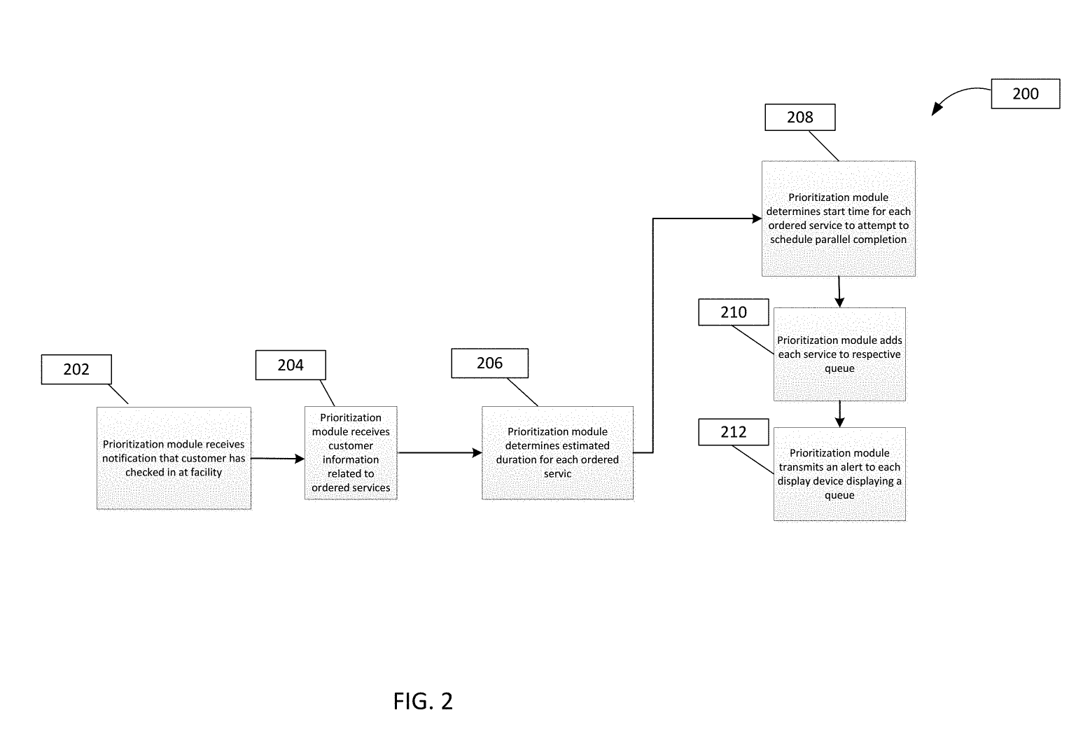

FIG. 2 illustrates an exemplary method 200 for integrating ordered services in an exemplary embodiment. The method is implemented using at least two display devices (e.g., display devices 115, 116 shown in FIG. 1) each configured to display a queue of services and viewable by one or more facility employees and/or customers. The method is further implemented using a data storage device (e.g., data storage device 105 shown in FIG. 1) storing customer information and estimated durations of services. The method is also implemented using a server (e.g., server 120 shown in FIG. 1) communicatively coupled to the data storage device, the at least two display devices, and a user device (e.g., user device 110 shown in FIG. 1).

As described previously, a customer may use a computing device, for example, user device 110, to create multiple ordered services. It will be appreciated that the ordered services may also be created for the customer by a third party such as a facility associate. The sequence begins when the prioritization module being executed by the server receives a notification that the customer has checked in to the facility (step 202). In one embodiment, the customer affirmatively checks in via a user device such as a shared kiosk or a personal mobile computing device (e.g. a smart phone). For example, the check-in may be made via a provided user interface from an application executing on the personal mobile computing device or kiosk (e.g. application 130 as shown in FIG. 1). Alternatively, the check-in may be an automatic process that occurs when a customer's mobile device is detected in a facility (e.g. when a facility uses a beacon or other location-based mechanism). The prioritization module requests and receives customer information associated with the customer from at least one of the data storage device or the user device (step 204). The customer information includes information about ordered services that are available to be performed at the facility. Each ordered service is associated with a service type. For example, the service types may include, but are not limited to, automotive repairs, food preparations, shopping, pharmacy orders, and money transfers.

If the customer information is stored in the data storage device the prioritization module retrieves the customer information from the data storage device. Alternatively, if customer information associated with the customer is not stored in the data storage device the customer enters the customer information into the shared computing device which is then transmitted to the prioritization module. The prioritization module determines a start time for performing each ordered service of the plurality of ordered services based on the service type and an expected duration of each ordered service (step 208). The queue placement for an ordered service is determined based on at least the expected duration and/or the start time of the ordered service with the aim of scheduling both services to complete at approximately the same time.

After determining the start times, the prioritization module assigns each ordered service a spot in a separate queue depending on a service type of each ordered service (step 210). The updated queue listings are transmitted to the display devices. Each queue is displayed on a display device and is viewable by customers and/or facility employees. The prioritization module also transmits an alert for each ordered service to each display device (step 212). The alert is associated with a start time for beginning the ordered service associated with the alert. The display device may be, for example, a mobile computing device used by one or more facility employees or a wall-mounted display device viewable by one or more facility employees. Each alert for each ordered service may be transmitted at different times depending on the expected duration and/or the start time of each ordered service. The alert may trigger an audible or visible effect at the display device using device capabilities that is designed to draw attention to the display device.

Following the alert, at least one employee begins performance of the ordered service. Any changes in order status may be displayed on each display device. The change in order status may occur at different times depending on the status of each ordered service. For example, a display device may display an alert that the ordered service should begin or that the ordered service is in progress. In another embodiment, if the customer used a personal mobile device, the customer may receive changes in order status on the personal mobile device. The prioritization module may receive a notification that a service has been completed after an employee enters an update. The employee completing the service may then move on to another ordered service.

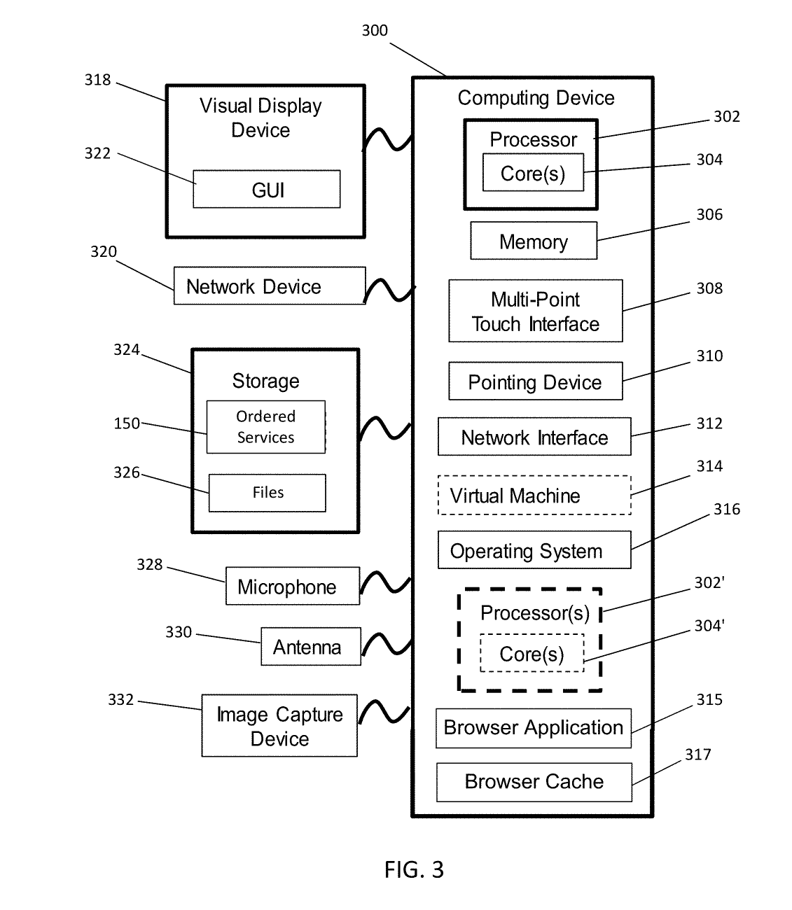

FIG. 3 is a block diagram of an example computing device 300 that can be used to perform one or more steps of the methods provided by exemplary embodiments. In an exemplary embodiment, computing device 300 is a server (e.g. server 120 as shown in FIG. 1) and/or a user device (e.g. user device 110 shown in FIG. 1). Computing device 300 includes one or more non-transitory computer-readable media for storing one or more computer-executable instructions or software for implementing exemplary embodiments such as the prioritization module described herein. The non-transitory computer-readable media can include, but are not limited to, one or more types of hardware memory, non-transitory tangible media (for example, one or more magnetic storage disks, one or more optical disks, one or more USB flashdrives), and the like. For example, a memory 306 included in computing device 300 can store computer-readable and computer-executable instructions or software for implementing exemplary embodiments such as the prioritization module described herein. Computing device 300 also includes a processor 302 and an associated core 304, and optionally, one or more additional processor(s) 302′ and associated core(s) 304′ (for example, in the case of computer systems having multiple processors/cores), for executing computer-readable and computer-executable instructions or software stored in memory 306 and other programs for controlling system hardware. Processor 302 and processor(s) 302′ can each be a single core processor or multiple core (304 and 304′) processor.

Computing device 300 may include a browser application 315 and a browser cache 317. As described above, browser application 315 can enable a customer to select files and/or file links, and receive a file.

Virtualization can be employed in computing device 300 so that infrastructure and resources in the computing device can be shared dynamically. A virtual machine 314 can be provided to handle a process running on multiple processors so that the process appears to be using only one computing resource rather than multiple computing resources. Multiple virtual machines can also be used with one processor.

Memory 306 can include a computer system memory or random access memory, such as DRAM, SRAM, EDO RAM, and the like. Memory 306 can include other types of memory as well, or combinations thereof. In some embodiments, a customer can interact with computing device 300 through a visual display device 318, such as a touch screen display or computer monitor, which can display one or more customer interfaces 319 that can be provided in accordance with exemplary embodiments. Visual display device 318 may also display other aspects, elements and/or information or data associated with exemplary embodiments. Computing device 300 may include other I/O devices for receiving input from a customer, for example, a keyboard or any suitable multi-point touch interface 308, a pointing device 310 (e.g., a pen, stylus, mouse, or trackpad). The keyboard 308 and pointing device 310 may be coupled to visual display device 318. Computing device 300 may include other suitable conventional I/O peripherals.

Computing device 300 can also include one or more storage devices 324, such as a hard-drive, CD-ROM, or other computer readable media, for storing data and computer-readable instructions and/or software, that implements embodiments of the specialized computer file system, as described herein, or portions thereof. Exemplary storage device 324 can also store one or more storage devices for storing any suitable information required to implement exemplary embodiments, such as ordered services 150.

Computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 can include a built-in network adapter, network interface card, PCMCIA network card, card bus network adapter, wireless network adapter, USB network adapter, modem or any other device suitable for interfacing computing device 300 to any type of network capable of communication and performing the operations described herein. Moreover, computing device 300 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 300 can run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 316 can be run in native mode or emulated mode. In an exemplary embodiment, the operating system 316 can be run on one or more cloud machine instances.

The description herein is presented to enable any person skilled in the art to create and use a computer system configuration and related method and systems for improving access to electronic data. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system for prioritizing and integrating ordered services, the system comprising:
at least two display devices, each display device configured to display a queue of services, wherein each queue is of a different service type;
a data storage device storing customer information and estimated durations of different types of services; and
a server communicatively coupled to the data storage device, the at least two display devices, and a user device, the server configured to execute a prioritization module that when executed:
receives a notification that a customer has checked in at a facility, the notification including customer credentials;
receives customer information associated with the customer from at least one of the data storage device or the user device, wherein the customer information includes two or more services of different types ordered by the customer and available to be performed at the facility;
determines an estimated duration of each ordered service of the two or more ordered services;
determines a start time for performing each ordered service of the two or more ordered services based on the estimated duration of each type of ordered service such that the two or more ordered services are scheduled to be completed at approximately a same time;
adds each ordered service of the two or more ordered services to separate queues, wherein a placement in the queue for an ordered service is determined based at least in part on the estimated duration of the type of ordered service and the start time of the ordered service; and
transmits an alert to each display device of the at least two display devices for each ordered service, wherein the alert indicates the start time for beginning each ordered service of the two or more ordered services.

2. The system of claim 1, wherein the prioritization module when executed further:
receives a notification that a first ordered service of the two or more ordered services has been completed; and
transmits the notification that the first ordered service has been completed to a display device of the at least two display devices.

3. The system of claim 1, wherein the user device is a mobile computing device or a kiosk.

4. The system of claim 1, wherein each queue is displayed on at least the user device, a mobile computing device, or at least one wall-mounted display device viewable by at least by one or more facility employees or the customer.

5. The system of claim 1, wherein the user device is configured to use location-based wireless communication to check in to the facility.

6. The system of claim 1, wherein the prioritization module when executed further :
determines an estimated completion time of the later of the two or more ordered services; and
transmits the estimated completion time to the user device.

7. The system of claim 1, wherein the prioritization module is further configured to transmit a notification to the user device that the two or more ordered services have been completed.

8. The system of claim 1 wherein a placement in the queue is also based in part on at least one of a priority of a task and a priority of assigned to the customer.

9. A computer-implemented method for prioritizing and integrating ordered services, comprising:
receiving, with a prioritization module executing on a server, a notification that a customer has checked in at a facility, the notification including customer credentials;
receiving, with the prioritization module, customer information associated with the customer from at least one of a data storage device storing customer information and estimated durations of different types of services or a user device, wherein the customer information includes two or more services of different types ordered by the customer and available to be performed at the facility;
determining, by the prioritization module, an estimated duration of each ordered service of the two or more ordered services;
determining, by the prioritization module, a start time for performing each ordered service of the two or more ordered services based on the estimated duration of each type of ordered service such that the two or more ordered services are scheduled to be completed at approximately a same time;
adding, by the prioritization module, each ordered service of the two or more ordered services to separate queues, wherein a placement in the queue for an ordered service is determined based at least in part on the estimated duration of the type of ordered service and the start time of the ordered service; and
transmitting, by the prioritization module, an alert for each ordered service to each display device configured to display a queue of services, wherein the alert indicates the start time for beginning each ordered service of the two or more ordered services.

10. The method of claim 9, wherein the user device is a mobile computing device or a kiosk.

11. The method of claim 9, wherein the queue is displayed on at least the user device, a mobile computing device, or at least one wall-mounted display device viewable by at least one or more facility employees or the customer.

12. The method of claim 9, wherein the user device is configured to use location-based wireless communication to check in to the facility.

13. The method of claim 9, further comprising:
determining, by the prioritization module, an estimated completion time of the two or more ordered services; and
transmitting, by the prioritization module, the estimated completion time to the user device.

14. The method of claim 9, further comprising transmitting, by the prioritization module, a notification to the user device that the two or more ordered services have been completed.

15. The method of claim 9 wherein a placement in the queue is also based in part on at least one of a priority of a task and a priority of assigned to the customer.

16. A non-transitory computer-readable medium storing instructions for prioritizing and integrating ordered services, the instructions when executed causing at least one server to:
receive a notification that a customer has checked in at a facility, the notification including customer credentials;
receive customer information associated with the customer from at least one of a data storage device storing customer information and estimated durations of different types of services or a user device, wherein the customer information includes two or more services of different types ordered by the customer and available to be performed at the facility;
determine an estimated duration of each ordered service of the two or more ordered services;
determine a start time for performing each ordered service of the two or more ordered services based on the estimated duration of each type of ordered service such that the two or more ordered services are scheduled to be completed at approximately a same time;
add, by the at least one server, each ordered service of the two or more ordered services to separate queues, wherein a placement in the queue for an ordered service is determined based at least in part on the estimated duration of the type of ordered service and the start time of the ordered service; and
transmit, by the at least one server, an alert for each ordered service to each display device configured to display a queue of services, wherein the alert indicates the start time for beginning each ordered service of the two or more ordered services.

17. The non-transitory computer readable medium of 16, wherein the instructions when executed further cause the at least one server to:
receive a notification that a first ordered service of the two or more ordered services has been completed; and
transmit the notification that the first ordered service has been completed to a display device.

18. The non-transitory computer-readable medium of claim 16 wherein a placement in the queue is also based in part on at least one of a priority of a task and a priority of assigned to the customer.

19. The non-transitory computer readable medium of 16, wherein the user device is configured to use location-based wireless communication to check in to the facility.

20. The non-transitory computer readable medium of 16, wherein the instructions when executed further cause the at least one server to:
determine an estimated completion time of the two or more ordered services; and
transmit the estimated completion time to the user device.
